(19) United States
(12) Patent Application Publication
(10) Pub. No.: US 2016/0292271 A1
(43) Pub. Date: Oct. 6, 2016

(54) ELECTRONIC DEVICE FOR PROVIDING SOUND SOURCE AND METHOD THEREOF

(71) Applicant: Samsung Electronics Co., Ltd., Gyeonggi-do (KR)

(72) Inventors: Jae-Pil KIM, Gyeonggi-do (KR); Sun-Tae JUNG, Gyeonggi-do (KR)

(73) Assignee: Samsung Electronics Co., Ltd.

(21) Appl. No.: 15/182,176

(22) Filed: Jun. 14, 2016

Related U.S. Application Data
(63) Continuation-in-part of application No. 12/693,159, filed on Jan. 25, 2010.

(30) Foreign Application Priority Data
Jan. 23, 2009 (KR) 10-2009-0005932

(51) Int. Cl. G06F 17/30; G06F 3/16; G06F 3/01

(52) U.S. Cl. CPC G06F 17/30764; G06F 3/015; G06F 3/165; G06F 17/30772; G06F 17/30749; G06F 17/30867

(57) ABSTRACT

A device for searching for music using a biological signal and a method thereof are provided. The method includes obtaining biological information of a user; obtaining information about sound source data corresponding to the obtained biological information; and mapping the obtained biological information to the obtained information about the sound source data and transferring the mapping result to a server.

### PRIORITY

This application is a continuation-in-part of application Ser. No. 12/693,159, filed Jan. 25, 2010, which claims priority under 35 U.S.C. §119(a) of a Korean patent application filed in the Korean Intellectual Property Office on Jan. 23, 2009 and assigned Serial No. 10-2009-0005932, the entire disclosure of which is incorporated herein by reference.

### BACKGROUND

1. Field of the Disclosure

The present disclosure relates generally to a music search apparatus, and more particularly, to an electronic device and method for providing sound source data using a biological signal such as an ElectroCardioGram (ECG) or a PhotoPlethysmoGraphy (PPG), and a method thereof.

2. Description of the Related Art

Users often listen to music while exercising. Based on study results showing that listening to music during exercise has a positive influence on exercise results, a method for searching for music according to a user's heart rate has been developed.

The music search method involves setting a target heart rate for a user, detecting an actual heart rate of the user engaged in exercise, and comparing the detected heart rate with the target heart rate. If the detected heart rate is less than the target heart rate, music having a fast tempo may be updated in a current music play list so that the user may exercise while listening to the fast-tempo music.

If the detected heart rate is greater than the target heart rate, music having a slow tempo may be updated in the current music play list so that the user may exercise while listening to the slow-tempo music.

In this manner, the music search method may compare the current heart rate of the user with the target heart rate to search for music matching a user's current condition, such that the found music can be played back by a music player in real time during the user's exercise.

In addition to the aforementioned music search method using the user's heart rate, a music search method using a user's whistle or humming has also been proposed. This music search method uses a change in pitch of the user's humming data entered through a microphone to search for content in a database which stores sound sources.

As such, conventionally, a heart rate detected from an ECG during exercise is compared with a target heart rate and music having a fast or slow tempo is searched for and played depending on the comparison result.

However, conventional music search methods may have difficulty in searching for music reflecting a user's preference because these methods use objective numerical data such as music tempos and sound source data sizes per channel based on the user's heart rate only.

Furthermore, the found music may only have a fast or slow tempo, which may be disinteresting to the user.

Moreover, when music is searched for by using the user's whistle or humming, the accuracy of the search may be negatively impacted depending on the quality of the humming.

The above information is presented as background information only to assist with an understanding of the present disclosure. No determination has been made, and no assertion is made, as to whether any of the above might be applicable as prior art with regard to the present disclosure.

### SUMMARY

Accordingly, an aspect of the present disclosure is to provide an electronic device for providing sound source data in which user preferences are reflected, using a biological signal, and a method thereof.

In accordance with an aspect of the present disclosure, a method for providing a sound source in a first electronic device is provided. The method includes obtaining biological information of a user; obtaining information about sound source data corresponding to the obtained biological information; and mapping the obtained biological information to the obtained information about the sound source data and transferring the mapping result to a server.

In accordance with an aspect of the present disclosure, an electronic device for providing a sound source is provided. The electronic device includes a sensor module configured to measure biological information of a user; and a processor configured to obtain situation information of the user, obtain information about sound source data corresponding to the obtained biological information, map the obtained biological information to the obtained information about the sound source data, and transfer the mapping result to a server.

In accordance with an aspect of the present disclosure, there is provided a method for providing a sound source in a first electronic device. The method includes obtaining biological information of a user; obtaining information about sound source data corresponding to the obtained biological information; and mapping the obtained biological information to the obtained information about the sound source data and transferring the mapping result to a server.

In accordance with an aspect of the present disclosure, an electronic device for providing a sound source is provided. The electronic device includes a sensor module configured to measure biological information of a user; and a processor configured to obtain situation information of the user, obtain information about sound source data corresponding to the obtained biological information, map the obtained biological information to the obtained information about the sound source data, and transfer the mapping result to a server.

### BRIEF DESCRIPTION OF THE DRAWINGS

The above and other aspects, features and advantages of certain embodiments of the present disclosure will be more apparent from the following description taken in conjunction with the accompanying drawings, in which:

FIG. 1 illustrates a configuration of a music search apparatus according to various embodiments of the present disclosure;

FIG. 2 illustrates an example for a description of a feature information table according to various embodiments of the present disclosure;

FIG. 3 illustrates a flowchart showing a process of generating the feature information table by the music search apparatus according to various embodiments of the present disclosure;

FIG. 4 illustrates a flowchart showing a process of searching for a user preferred sound source using the feature information table by the music search apparatus according to various embodiments of the present disclosure;

FIGS. 5A, 5B, 6 and 7 illustrate examples of sound source providing systems for providing a user preferred sound source according to various embodiments of the present disclosure;

FIGS. 8A, 8B and 8C illustrate configurations of a first terminal, a second terminal and a server according to various embodiments of the present disclosure;

FIG. 9 illustrates a flowchart showing a process of providing sound source data corresponding to user's situation information and biological information in a first terminal according to various embodiments of the present disclosure;

FIG. 10 illustrates a flowchart showing a process of providing sound source data corresponding to user's situation information and biological information in a server according to various embodiments of the present disclosure;

FIG. 11 illustrates a flowchart showing a process of providing sound source data corresponding to user's situation information and biological information in a second terminal according to various embodiments of the present disclosure;

FIG. 12 illustrates a flowchart showing a process of providing sound source data corresponding to user's biological information in a sound source providing system according to various embodiments of the present disclosure;

FIG. 13 illustrates a flowchart showing a process of providing sound source data corresponding to user's biological information in a sound source providing system according to various embodiments of the present disclosure;

FIG. 14 illustrates a flowchart showing a process of providing sound source data corresponding to user's biological information in a sound source providing system according to various embodiments of the present disclosure;

FIGS. 15A and 15B illustrate examples for a description of a process of providing sound source data corresponding to user's situation information and/or biological information in a first terminal according to various embodiments of the present disclosure;

FIGS. 16A, 16B and 16C illustrate examples for a description of a process of providing sound source data corresponding to user's situation information and/or biological information in a first terminal according to various embodiments of the present disclosure; and

FIGS. 17A and 17B illustrate examples for a description of a process of providing sound source data corresponding to user's situation information and/or biological information in a first terminal according to various embodiments of the present disclosure.

### DETAILED DESCRIPTION OF EMBODIMENTS OF THE PRESENT DISCLOSURE

Hereinafter, embodiments of the present disclosure will be described in detail with reference to the accompanying drawings. Detailed descriptions of well-known functions and constructions are omitted for the sake of clarity and conciseness. Throughout the drawings, like reference numerals will be understood to refer to like parts, components, and structures.

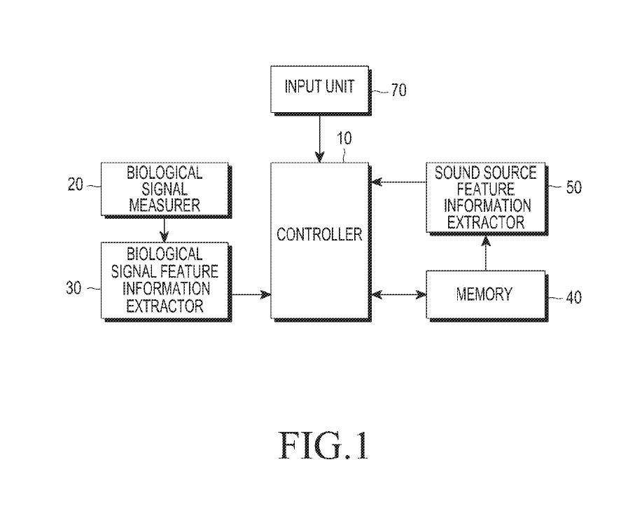

FIG. 1 illustrates a configuration of a music search apparatus according to various embodiments of the present disclosure.

Referring to FIG. 1, the music search apparatus includes a controller 10, a biological signal measurer 20, a biological signal feature information extractor 30, a memory 40, a sound source feature information extractor 50, and an input unit 70.

The controller 10 controls an overall step of the music search apparatus, and particularly, determines whether a category input has been made by a user through the input unit 70. A user situation-based category indicates a user situation such as exercise, rest, or fatigue.

The controller 10 receives the user's selection for a sound source preferred by the user for each category through the input unit 70.

The controller 10 generates music selection lists of sound sources selected by the user for respective user situation-based categories. That is, the generated music selection lists may include a music selection list of sound sources that the user desires to listen to when exercising, a music selection list of sound sources that the user desires to listen to when resting, and a music selection list of sound sources that the user desires to listen to when feeling fatigued.

The controller 10 controls the sound source feature information extractor 50 to extract sound source feature information about each of sound sources included in the generated music selection list. The sound source feature information may include information such as a title, a singer, a pitch change, a tempo, and a sound length of a sound source

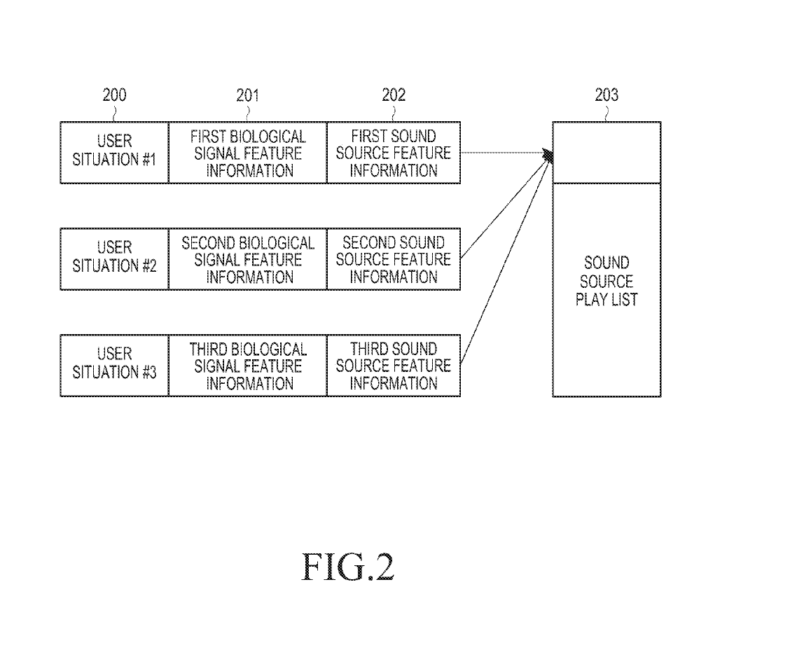

The controller 10 maps the extracted sound source feature information to the corresponding user situation-based category and stores mapping data (or mapping result) therebetween in the memory 40. Specifically, referring to FIG. 2, the controller 10 maps a user situation #1 200 entered through the input unit 70 to extracted first sound source feature information 202 and stores mapping data therebetween.

Thereafter, if a biological signal measurement request is entered through the input unit 70, the controller 10 controls the biological signal measurer 20 to measure a biological signal (or bio-signal) such as the ECG or PPG of the user, and controls the biological signal feature information extractor 30 to extract bio-signal feature information about the measured bio-signal. The bio-signal feature information includes information about maximum, minimum, mean, and standard deviations of the heart rate, and Heart Rate Variability (HRV). The user may measure the bio-signal while listening to selected music.

The controller 10 generates a feature information table in which the first bio-signal feature information 201 extracted by the biological signal feature information extractor 30 is matched to the first sound source feature information 202 corresponding to the user situation #1 200, as shown in FIG. 2.

If a sound source update request is entered through the input unit 70, the controller 10 controls the biological signal measurer 20 to measure a bio-signal of the user, and controls the biological signal feature information extractor 30 to extract bio-signal feature information.

The controller 10 compares bio-signal feature information stored in the feature information table with the extracted bio-signal feature information to detect bio-signal feature information similar to the extracted bio-signal feature information from the feature information table. The controller 10 determines that bio-signal feature information stored in the feature information table is similar to the extracted bio-signal feature information if a difference therebetween is less than a predetermined threshold.

The controller 10 extracts sound source feature information corresponding to the detected similar bio-signal feature information and compares the extracted sound source feature information with sound source feature information about sound sources stored in the memory 40.

The controller 10 detects a sound source having sound source feature information similar to the extracted sound source feature information from the memory 40. The controller 10 determines that sound source feature information about a sound source stored in the memory unit 40 is similar to the extracted sound source feature information if a difference therebetween is less than a predetermined threshold.

Thereafter, the controller 10 updates the detected sound sources in a sound source play list 203. In the present disclosure, the controller 10 may extract a sound source having sound source feature information similar to sound source feature information stored for each user situation-based category to generate a sound source update list during generation of the feature information table, instead of updating the sound source play list 203 on a real time basis.

In this regard, in the present disclosure, a sound source being similar to a user preferred sound source can be searched for (or retrieved) and provided based on a user situation.

The biological signal measurer 20 measures a bio-signal such as an ECG or a PPG and transfers the measured bio-signal to the biological signal feature information extractor 30. Specifically, the biological signal measurer 20 measures the bio-signal such as the ECG or the PPG and extracts heart rate information based on peak information about respective bits of the measured bio-signal. Thereafter, the biological signal measurer 20 extracts an HRV, using the extracted heart rate information.

The biological signal feature information extractor 30 extracts bio-signal feature information about the received bio-signal. Specifically, the biological signal feature information extractor 30 may extract feature information associated with a heart rate, feature information obtained through wavelet transform for respective bits of the bio-signal, and feature information obtained using frequency characteristic values of the HRV. In particular, the biological signal feature information extractor 30 may extract, as the bio-signal feature information, a power spectrum value, which is an integral value of a Power Spectrum Density (PSD) between a low-frequency band and a high-frequency band determined from a frequency component acquired by Fast Fourier Transform (FFT) with respect to maximum, minimum, mean, and standard deviations of the heart rate, and the HRV.

The memory 40 stores a plurality of sound sources, a sound source play list, a sound source update list, and a feature information table.

The sound source feature information extractor 50 extracts sound source feature information about a sound source selected through the input unit 70. The extracted sound source feature information may include information such as a pitch change, a sound length, and a tempo.

The input unit 70 receives a user situation-based category from the user in response to a sound source search request, and also receives a selection of a sound source for the received user situation-based category. Further, the input unit 70 receives a sound source update request.

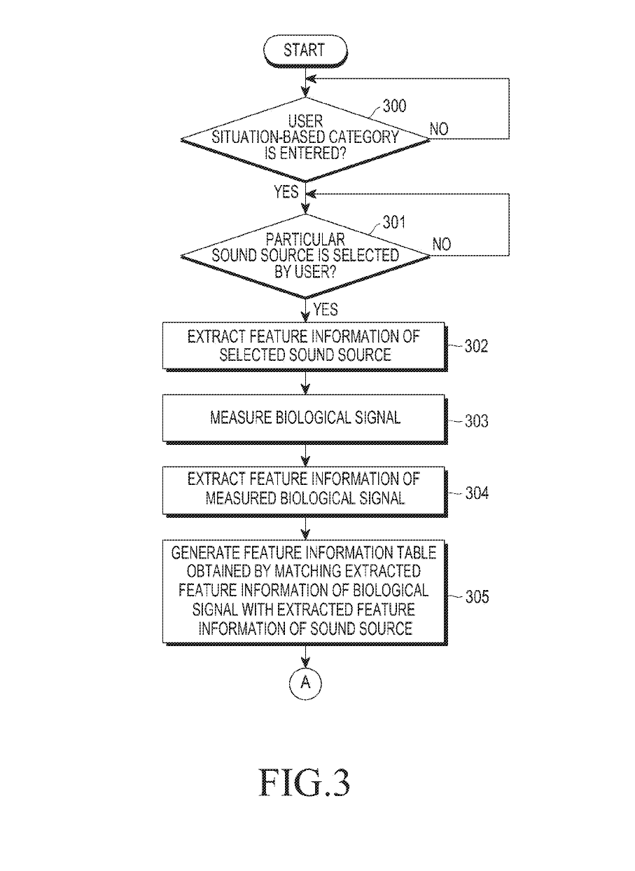

FIG. 3 illustrates a flowchart showing a process of generating the feature information table by the music search apparatus according to various embodiments of the present disclosure.

Referring to FIG. 3, the controller 10 proceeds to step 301, if a user situation-based category is entered by the user through the input unit 70 in step 300. Otherwise, the controller 10 continuously determines in step 300 whether a user situation-based category is entered through the input unit 70. The user situation-based category indicates a user situation such as exercise, rest, or fatigue.

The controller 10 determines in step 301 whether a user preferred sound source is entered (or selected) by the user for each user situation-based category through the input unit 70. If so, the controller 10 proceeds to step 302. Otherwise, the controller 10 continuously determines in step 301 whether a user preferred sound source is entered.

In step 302, the controller 10 controls the sound source feature information extractor 50 to extract sound source feature information about the selected user preferred sound source, and maps the extracted sound source feature information to the entered user situation-based category and stores mapping data therebetween.

In step 303, the controller 10 controls the biological signal measurer 20 to measure a bio-signal.

In step 304, the controller 10 controls the biological signal feature information extractor 30 to extract bio-signal feature information about the measured bio-signal. In step 305, the controller 10 generates a feature information table in which the extracted bio-signal feature information is mapped to the sound source feature information, and stores the feature information table in the memory 40.

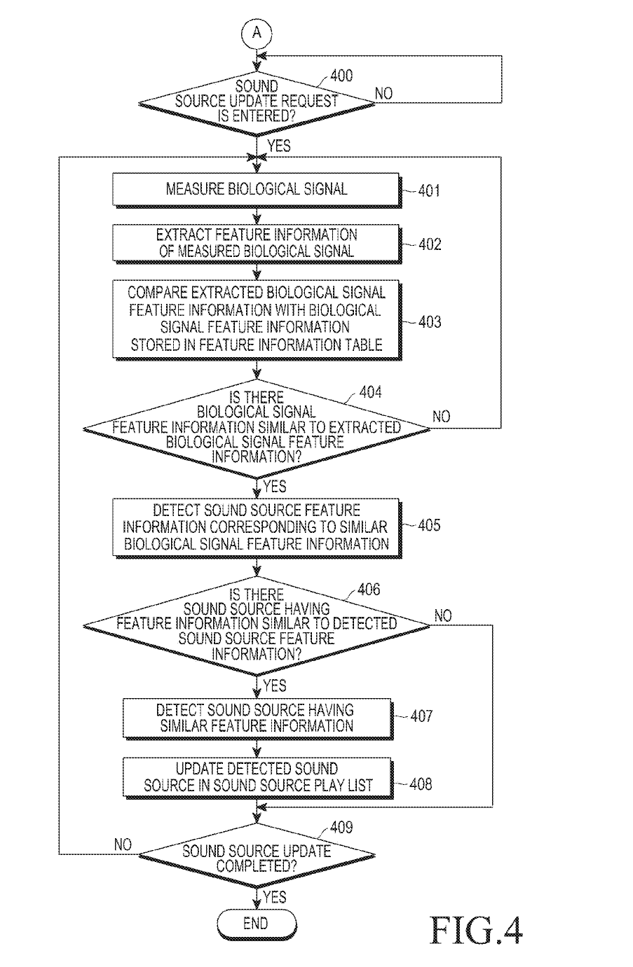

After step 305, the process proceeds to (A) which, together with subsequent steps thereof, will be shown in FIG. 4. With reference to FIG. 4, a detailed description will be made of a process of searching for the user preferred sound source by using the feature information table. Herein, (A) of FIG. 4 continues from (A) of FIG. 3.

FIG. 4 illustrates a flowchart showing a process of searching for a user preferred sound source using the feature information table by the music search apparatus according to various embodiments of the present disclosure.

In step 400, the controller 10 determines whether a sound source update request is entered by the user through the input unit 70. If so, the controller 10 proceeds to step 401. Otherwise, the controller 10 continuously determines in step 400 whether the sound source update request is entered.

In step 401, the controller 10 controls the biological signal measurer 20 to measure the current bio-signal of the user.

In step 402, the controller 10 controls the biological signal feature information extractor 30 to extract bio-signal feature information about the measured bio-signal.

In step 403, the controller 10 compares the extracted bio-signal feature information with bio-signal feature information stored in the feature information table.

In step 404, the controller 10 determines whether there exists bio-signal feature information similar to the measured bio-signal feature information from among the bio-signal feature information stored in the feature information table. If so, the controller 10 proceeds to step 405. Otherwise, the controller 10 returns to step 401 to control the biological signal measurer 20 to re-measure the current bio-signal of the user.

In step 405, the controller 10 detects the similar bio-signal feature information from the feature information table, and detects sound source feature information corresponding to the detected similar bio-signal feature information from the feature information table.

In step 406, the controller 10 determines whether there exists a sound source having sound source feature information similar to the detected sound source feature information from among the sound sources stored in the memory 40. If so, the controller 10 proceeds to step 407. Otherwise, the controller 10 proceeds to step 409.

In step 407, the controller 10 detects the sound source having the similar sound source feature information from the memory 40.

In step 408, the controller 10 updates the detected sound source in the current sound source play list.

The controller 10, which has proceeded to step 409 from step 406 or step 408, determines whether the sound source update has been completed. If not, the controller 10 returns to perform step 401 for bio-signal measurement, and then performs its subsequent steps 402 to 409.

In various embodiments, a device storing sound source information corresponding to user's situation information and biological information may, if biological information based on the user's situation information is measured, search for and provide sound source information corresponding to measured biological information.

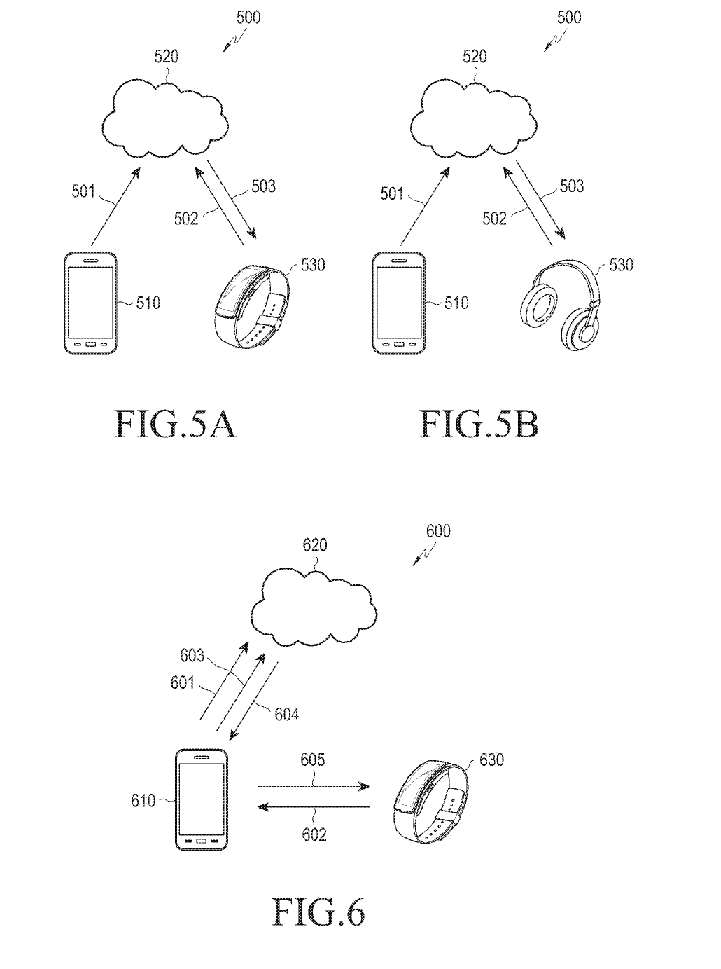

FIGS. 5A, 5B, 6 and 7 illustrate examples of sound source providing systems for providing a user preferred sound source according to various embodiments of the present disclosure.

Referring to FIGS. 5A and 5B, a sound source providing system 500 according to various embodiments of the present disclosure may include two or more devices. The sound source providing system 500 may include a first terminal 510 for requesting sound source data, a server 520 for providing the sound source data, and a second terminal 530 for receiving and outputting the sound source data. For example, the first terminal 510 may include a smart phone, a tablet PC or the like, which has a touch screen to receive a user input. The second terminal 530 may include a wearable device (such as a smart watch), a wired/wireless earphone or headset or the like, which includes a speaker, has a small storage space and a low-performance processor compared with the first terminal 510, and supports data communication. In various embodiments, the first terminal 510 and the second terminal 530 may be connected to each other by short-range communication such as Bluetooth, wireless fidelity (Wi-Fi), and Wi-Fi Direct.

In one embodiment, the first terminal 510 may obtain situation (or state) information (e.g., working, rest, jogging, walking, climbing, exercise or the like) representing the user's situation (or state), and obtain biological information (e.g., blood glucose, heart rate, blood pressure, body fat, body weight or the like) corresponding to the obtained situation information.

In one embodiment, the first terminal 510 may provide a user interface for selecting (or entering) the user's situation (or state), and obtain situation information corresponding to the user's situation (or state) that is selected (or entered) through the provided user interface.

In one embodiment, the first terminal 510 may obtain user data such as the user's location, schedule, time information, heart rate, blood pressure or the like, using at least one sensor or application, and determine the user's situation (or state) based on the obtained user data. For example, if the user's location measured through at least one sensor is ‘mountain’ and the measured heart rate is ‘130 bpm’ or higher, the first terminal 510 may determine that the user is climbing, and obtain the situation information (e.g., climbing) depending on the determination. In various embodiments, the first terminal 510 may store a table in which predetermined user's situation information is mapped to user data, and identify the user's situation information corresponding to the user data obtained through at least one sensor or application using the stored table.

In one embodiment, the first terminal 510 may select at least one sound source data in response to the obtained situation information and user's biological information according thereto, and transfer the situation information, the biological information and information about the selected at least one sound source data to the server 520. In various embodiments, although the first terminal 510 obtains both of the situation information and the biological information, the first terminal 510 may obtain any one of the situation information or the biological information, and select at least one sound source data in response to the obtained situation information or biological information.

In one embodiment, the server 520 may store the situation information and/or biological information and the information about the selected at least one sound source data, which are received from the first terminal 510. In one embodiment, the server 520 may store at least one sound source data in response to a variety of situation and biological information.

If first situation information and/or first biological information are received from the second terminal 530, the server 520 may search for at least one sound source data corresponding to the received first situation information and/or first biological information from among the pre-stored sound source data, and transfer the searched (or found) at least one sound source data to the second terminal 530. The sound source data may be sound source streaming data.

In one embodiment, the second terminal 530 may obtain first situation information and/or first biological information of the user in response to a user-preferred sound source data request (e.g., sound source streaming service request), and transfer the obtained first situation information and/or first biological information to the server 520. For example, the second terminal 530 may generate a sound source data request message including first situation information and/or first biological information, and transfer the generated sound source data request message to the server 520. In various embodiments, if a biological information request is received from the first terminal 510, the second terminal 530 may measure first biological information and transfer the measured first biological information to the first terminal 510.

If sound source data corresponding to the first situation information and/or the first biological information is received from the server 520, the second terminal 530 may output the received sound source data. For example, the second terminal 530 may receive a sound source data response message including the sound source data corresponding to the first situation information and/or the first biological information in response to the sound source data request message, and output the sound source data included in the received sound source data response message through a speaker of the second terminal 530.

Referring to FIGS. 5A and 5B, the first terminal 510 may obtain situation information and biological information of the user, and select sound source data corresponding to the obtained situation information and biological information. The selected sound source data may be user-preferred sound source data. The first terminal 510 may transfer, in step 501, the information (e.g., sound source title, singer name, genre, subject, bpm, sound source length, lyric, category, content data or the like) about the selected sound source data to the server 520, together with the obtained situation information and biological information.

In various embodiments, the first terminal 510 may provide a user interface for selecting user-preferred sound source data, obtain situation information and biological information of the user if the user-preferred sound source data is selected through the user interface, map information about the user-preferred sound source data to the obtained situation information and biological information, and store the mapping result or transfer the mapping result to the server 520.

In various embodiments, the first terminal 510 may obtain biological information of the user without obtaining situation information, and the first terminal 510 may map information about the user-preferred sound source data to the obtained biological information, and store the mapping result or transfer the mapping result to the server 520. For example, if specific sound source data is selected (e.g., if a Like button is selected) while the first terminal 510 is playing sound source data through a music playback application such as a music player, the first terminal 510 may measure biological information (e.g., heart rate), map information about the selected sound source data to the measured biological information, and store the mapping result or transfer the mapping result to the server 520. Otherwise, if a playback time of the sound source data being played through the music playback application is greater than or equal to a predetermined threshold time or if the playback of the sound source data has been completed, the first terminal 510 may determine the sound source data as the user-preferred sound source data. If a playback time of the sound source data being played is greater than or equal to a predetermined threshold time or if the playback of the sound source data has been completed, the first terminal 510 may measure biological information, map information about the sound source data to the measured biological information and store the mapping result or transfer the mapping result to the server 520.

In one embodiment, the server 520 may receive situation information, biological information and information about sound source data from the first terminal 510, map the situation information, the biological information and the information about sound source data to each other, and store the mapping result, and the server 520 may receive, in step 502, a request for sound source data corresponding to situation information (e.g., first situation information) and biological information (e.g., first biological information) of the user from the second terminal 530. The request for sound source data may include the first situation information and the first biological information. The server 520 may search for sound source data corresponding to the first situation information and the first biological information in response to the request, and transfer the searched sound source data to the second terminal 530 in step 503. For example, the server 520 may stream the searched sound source data, and transfer the streaming data to the second terminal 530.

In various embodiments, if the sound source data corresponding to the first situation information and the first biological information is not found, the server 520 may search for similar sound source data corresponding to situation information and biological information similar to the first situation information and the first biological information. For example, if the first situation information received from the second terminal 530 is ‘jogging’ and the first biological information is ‘heart rate: 120 bpm’, the server 520 may search for and provide the sound source data corresponding to the same situation information or the similar heart rate (e.g., 100 bpm or higher).

In one embodiment, the second terminal 530 may obtain first situation information and/or first biological information of the user in response to the occurrence of an event for receiving user-preferred sound source data, and transfer a sound source data request including the obtained first situation information and/or first biological information to the server 520, in step 502. The second terminal 530 may receive sound source data from the server 520 in response to the request in step 503, and output the received sound source data through a speaker of the second terminal 530. For example, if the sound source data is sound source streaming data, the second terminal 530 may output the sound source streaming data received from the server 520, through the speaker.

In various embodiments, if a request for measuring user's biological information is received from the first terminal 510, the second terminal 530 may measure first biological information of the user in response to the request, and transfer the measured first biological information to the first terminal 510 or the server 520.

Referring to FIG. 6, a sound source providing system 600 according to various embodiments of the present disclosure may include a first terminal 610, a server 620, and a second terminal 630 that is connected to the first terminal 610 by short-range communication. The second terminal 630 may be a device that does not support communication with the server 620, or supports only the short-range communication.

In one embodiment, the first terminal 610 may obtain situation information and/or biological information of the user, and select sound source data corresponding to the obtained situation information and/or biological information. For example, the first terminal 610 may provide a user interface for receiving the selection of the preferred sound source data from the user. The user interface may include a list of a variety of sound source data.

If the selection of the preferred sound source data is received through the user interface, the first terminal 610 may transfer the situation information and/or the biological information to the server 620, together with information about the selected sound source data, in step 601.

In one embodiment, the second terminal 630 may obtain situation information and biological information of the user in response to a user-preferred sound source data request (e.g., occurrence of an event), and transfer a sound source data request including the obtained situation information and biological information to the first terminal 610 that is connected to the second terminal 630 by short-range communication, in step 602.

Upon receiving the sound source data request, the first terminal 610 may forward the received sound source data request to the server 620 in step 603. In various embodiments, the first terminal 610 may generate a new request message including the situation information and the biological information, which are included in the sound source data request, and transfer the generated request message to the server 620.

Upon receiving the sound source data request, the server 620 may search for sound source data corresponding to the situation information and the biological information included in the sound source data request, and transfer a sound source data response including the searched sound source data to the first terminal 610 in step 604. In various embodiments, the server 620 may stream the sound source data, and transfer the streamed sound source data to the first terminal 610.

Upon receiving the sound source data response, the first terminal 610 may forward the sound source data response to the second terminal 630 in step 605. In various embodiments, the first terminal 610 may transfer the sound source data included in the received sound source data response to the second terminal 630.

The second terminal 630 may output the sound source data included in the received sound source data response through its speaker. In various embodiments, the second terminal 630 may output the sound source data received from the first terminal 610, through its speaker.

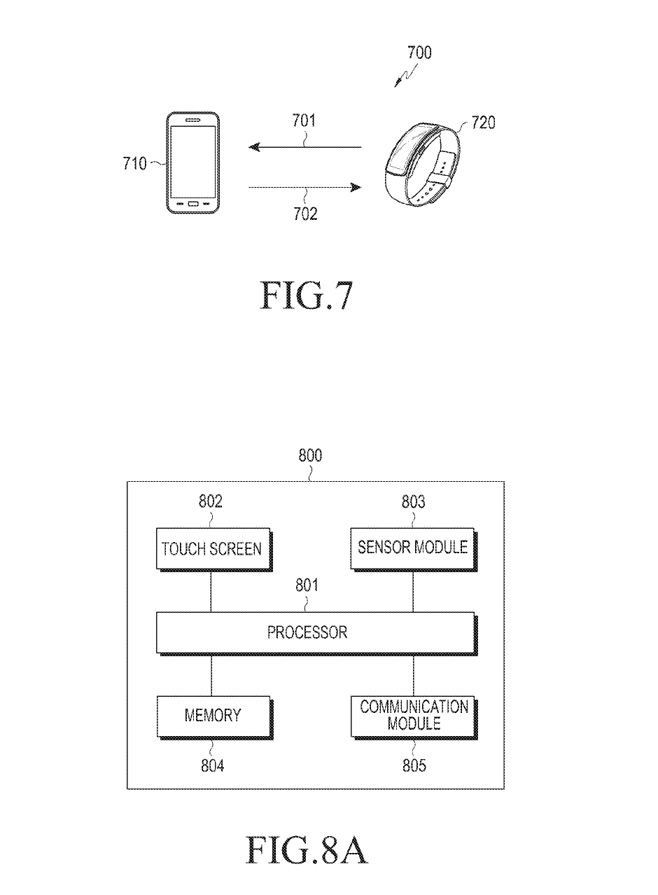

Referring to FIG. 7, a sound source providing system 700 according to various embodiments of the present disclosure may include a first terminal 710, and a second terminal 720 that is connected to the first terminal 710 by short-range communication. The sound source providing system 700 may not include a server, and the first terminal 710 may perform the above-described server's step.

In one embodiment, as described in FIG. 5, the first terminal 710 may obtain situation information and/or biological information of the user, map information about the sound source data to the obtained situation information and/or biological information, and store the mapping result. For example, the first terminal 710 may provide a user interface for selecting user-preferred sound source data depending on the obtained situation information and/or biological information, map information about the sound source data selected through the user interface to the obtained situation information and/or biological information, and store the mapping result.

In one embodiment, the second terminal 720 may obtain first situation information and first biological information of the user in response to the event occurrence (or request) for receiving user-preferred sound source data, and transfer a sound source data request message including the obtained first situation information and first biological information to the first terminal 710 in step 701.

Upon receiving the sound source data request message from the second terminal 720, the first terminal 710 may search for sound source data corresponding to the first situation information and/or the first biological information included in the received sound source data request message, and transfer a sound source data response message including the searched sound source data to the second terminal 720 in step 702. In various embodiments, if the sound source data corresponding to the first situation information and/or the first biological information is not found, the first terminal 710 may search for similar sound source data corresponding to situation information and/or biological information similar to the first situation information and/or the first biological information, and transfer the searched similar sound source data to the second terminal 720. The sound source data may be sound source streaming data. For example, the first terminal 710 may stream the searched sound source data, and transfer the streamed sound source data to the second terminal 720. The situation information similar to the first situation information may be situation information corresponding to the same user's location information or biological information. The biological information similar to the first biological information may have a measurement value, a difference of which from a measurement value of the first biological information is less than a predetermined threshold. For example, if the first situation information is ‘walking (e.g., location information: Park, and heart rate: 80 bpm)’, the situation information similar to the first situation information may include ‘jogging (e.g., location information: Park)’ or ‘walking (e.g., heart rate: 80 bpm)’. If the first biological information is ‘heart rate: 100 bpm’, the biological information similar to the first biological information may be a heart rate of 91˜99 bpm or 101˜109 bpm, a difference of which from the heart rate of 100 bpm is less than a predetermined threshold (e.g., 10 bpm).

Upon receiving sound source data from the first terminal 710, the second terminal 720 may output the received sound source data through its speaker. For example, upon receiving sound source streaming data from the first terminal 710, the second terminal 720 may output the received sound source streaming data through its speaker.

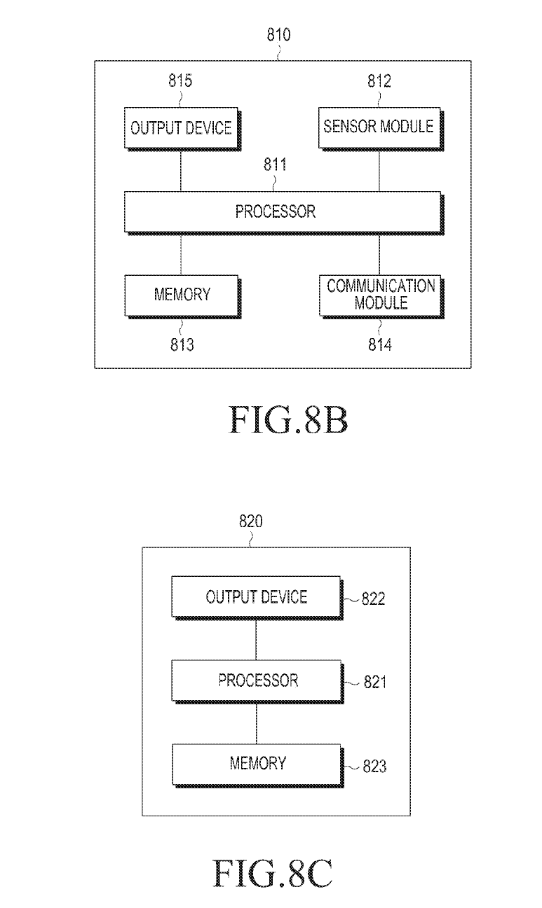

FIGS. 8A, 8B and 8C illustrate configurations of a first terminal, a second terminal and a server according to various embodiments of the present disclosure.

Referring to FIG. 8A, a first terminal 800 may include a processor 801, a touch screen 802, a sensor module 803, a memory 804 and a communication module 805.

In one embodiment, the processor 801 may control the sensor module 803 to obtain situation information of the user and measure biological information corresponding to the obtained situation information.

In one embodiment, the processor 801 may provide a first user interface for obtaining situation information of the user, and store the user's situation information selected (or entered) through the first user interface, in the memory 804. The processor 801 may provide a first user interface for selecting (or entering) situation information (e.g., working, rest, jogging, walking, climbing, exercise or the like) representing the situation of the user. If situation information is selected (or entered) through the first user interface, the processor 801 may provide a second user interface for requesting measurement of biological information. If measurement of biological information is requested through the second user interface, the processor 801 may control the sensor module 803 to measure biological information. For example, if the situation information of the user is ‘exercise’, the user may request to measure biological information of the user at the start, middle or end of the exercise through the second user interface. In this case, in response to the situation information such as ‘exercise’, the processor 801 may measure or obtain biological information measured at the start of the user's exercise, biological information measured in the middle of the user's exercise, or biological information measured at the end of the user's exercise.

In various embodiments, the processor 801 may control the sensor module 803 to measure biological information, if the situation information is selected (or entered) through the first user interface.

In one embodiment, the processor 801 may obtain location information and biological information of the user, using a location sensor, an acceleration sensor, a biometric sensor or the like, and determine the user's situation based on the obtained location information and biological information. For example, the processor 801 may store, in the memory 804, the situation information corresponding to the location information and the biological information as shown in Table 1 below, in order to determine the user's situation.

TABLE 1

| bio information (ex: heart | | |
|---|---|---|
| rate (bpm)) | location information | situation information |
| 120~150 | mountain | climbing |
| 160~180 | park | jogging |
| 170~200 | indoors | exercise |
| 70~110 | park | walking |
| . . . | . . . | . . . |

If the user's heart rate measured through the biometric sensor is “130 bpm” and the user's location obtained through the location sensor is “mountain”, the processor 801 may determine the user's situation information as “climbing”.

In various embodiments, the processor 801 may determine the user's situation using the location sensor and the acceleration sensor. For example, if the location measured through the location sensor is ‘mountain’ and the amount of exercise measured through the acceleration sensor is greater than a threshold, the processor 801 may determine the user's situation information as ‘climbing’. If the location measured through the location sensor is ‘park’ and the amount of exercise measured through the acceleration sensor is less than a threshold, the processor 801 may determine the user's situation information as ‘walking’.

In one embodiment, the processor 801 may obtain information about the user-preferred sound source data in response to the obtained situation information and/or biological information.

The processor 801 may provide a third user interface for selecting user-preferred sound source data corresponding to the situation information and/or the biological information, and store information about the sound source data selected through the third user interface, in the memory 804. For example, if a first user interface for selecting situation information is displayed on the touch screen 802 and situation information is selected through the first user interface displayed on the touch screen 802, the processor 801 may run a music playback application to play at least one sound source data at random. The processor 801 may display, on the touch screen 802, a playback screen for the sound source data being played through the music playback application. The playback screen may include a fourth user interface (e.g., a prefer icon, a prefer image or the like) for determining whether the user prefers the sound source data being played. If a prefer icon on the playback screen is selected (or touched), the processor 801 may determine the sound source data being played, as user-preferred sound source data.

In various embodiments, if the processor 801 provides a third user interface for selecting user-preferred sound source data corresponding to the situation information and specific sound source data is selected through the third user interface, the processor 801 may control the sensor module 803 to measure biological information of the user. For example, if situation information is selected through the first user interface, the processor 801 may display a sound source list including at least one sound source data on the touch screen 802, and if sound source data to be played is selected from the sound source list displayed on the touch screen 802, the processor 801 may control the sensor module 803 to measure biological information of the user.

In one embodiment, the processor 801 may map the obtained situation information, biological information and information about sound source data to each other, and store the mapping result in the memory 804 or transfer the mapping result to the server 820.

In various embodiments, the processor 801 may map the user's biological information and the information about the sound source data to each other without obtaining the user's situation information, or map the user's situation information and the information about the sound source data to each other without obtaining the user's biological information, and store the mapping result in the memory 804 or transfer the mapping result to the server 820.

In various embodiments, the processor 801 may control the sensor module 803 to measure biological information in response to the selection or playback of sound source data, map the measured biological information and information about the selected/played sound source data to each other, and store the mapping result in the memory 804 or transfer the mapping result to the server 820. For example, if the processor 801 runs a music playback application in response to a music playback request, if sound source data to be played is selected through the running music playback application, or if the selected sound source data is played, the processor 801 may control the sensor module 803 to measure biological information. If first sound source data is selected or played through the music playback application, the processor 801 may control the sensor module 803 to measure the user's biological information. If the biological information measured through the sensor module 803 is ‘heart rate: 130 bpm’, the processor 801 may map information about the first sound source data and the biological information ‘heart rate: 130 bpm’ to each other, and store the mapping result in the memory 804 or transfer the mapping result to the server 820.

In various embodiments, if a sound source data request message including first situation information and/or first biological information is received from a second terminal 810 through the communication module 805, the processor 801 may forward the received sound source data request message to the server 820 through the communication module 805. If sound source data or a sound source data response message including the sound source data is received from the server 820 in response to the sound source data request message, the processor 801 may forward the sound source data or the sound source data response message to the second terminal 810 through the communication module 805.

In various embodiments, if a sound source data request message including first situation information and/or first biological information is received from the second terminal 810 through the communication module 805, the processor 801 may search the memory 804 for sound source data corresponding to the first situation information and/or the first biological information, and transfer the searched sound source data to the second terminal 810 through the communication module 805. For example, if the first biological information is ‘heart rate: 130 bpm’, the processor 801 may search the memory 804 for sound source data corresponding to ‘heart rate: 130 bpm’, and transfer the searched sound source data to the second terminal 810. Otherwise, if the first situation information is ‘walking’, the processor 801 may search the memory 804 for sound source data corresponding to ‘walking’, and transfer the searched sound source data to the second terminal 810.

If the sound source data corresponding to ‘heart rate: 130 bpm’ and/or ‘walking’ is not found, the processor 801 may search for sound source data (e.g., similar sound source data) corresponding to situation information (e.g., 120˜130 bpm) and/or biological information (e.g., walking) similar to ‘heart rate: 130 bpm’ and/or ‘walking’, and provide the searched sound source data.

The touch screen (or a touch sensitive display) 802 may receive a touch input, a gesture input, a proximity input, a drag input, a swipe input or a hovering input, each of which can be made using a stylus pen or a part of the user's body. Further, the touch screen 802 may display a variety of content (e.g., text, images, video, icons and/or symbols).

The sensor module 803 may include a biometric sensor for measuring a biological signal, and may include at least one of a gesture sensor, a gyro sensor, a barometer sensor, a magnetic sensor, an acceleration sensor, a grip sensor, a proximity sensor, a color sensor (e.g., red-green-blue (RGB) sensor), a temperature/humidity sensor, an illuminance sensor, or a ultra violet (UV) sensor in addition to the biometric sensor. Additionally or alternatively, the sensor module 803 may include, for example, an E-nose sensor, an electromyography (EMG) sensor, an electroencephalogram (EEG) sensor, an electrocardiogram (ECG) sensor, an infrared (IR) sensor, an iris sensor and/or a fingerprint sensor. The sensor module 803 may further include a control circuit for controlling at least one or more sensors belonging thereto.

The memory 804 may include, for example, an internal memory or an external memory. The internal memory may include at least one of, for example, a volatile memory (e.g., dynamic RAM (DRAM), static RAM (SRAM), synchronous dynamic RAM (SDRAM) or the like), and a non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash, NOR flash or the like), hard drive, or solid state drive (SSD)).

In one embodiment, the memory 804 may store situation information and/or biological information, and may store user-preferred sound source data or information thereabout in response to the situation information and/or the biological information. The external memory may further include a flash memory, for example, compact flash (CF), secure digital (SD), micro secure digital (Micro-SD), mini secure digital (Mini-SD), extreme digital (xD), multi-media card (MMC), a memory stick or the like. The external memory may be functionally and/or physically connected to the first terminal 800 through a variety of interfaces.

The communication module 805 may include, for example, a cellular module, a WiFi module, a Bluetooth module, a global navigation satellite system (GNSS) module (e.g., global positioning system (GPS) module, a Glonass module, a Beidou module, or a Galileo), a near field communication (NFC) module, and a radio frequency (RF) module.

The cellular module may, for example, provide a voice call service, a video call service, a messaging service, an Internet service or the like over the communication network. In one embodiment, the cellular module may perform identification and authentication of the first terminal 800 within the communication network using a subscriber identification module (e.g., SIM card). In one embodiment, the cellular module may perform some of the functions that can be provided by the processor 801. In one embodiment, the cellular module may include a communication processor (CP).

Each of the WiFi module, the Bluetooth module, the GNSS module or the NFC module may include, for example, a processor for processing the data transmitted and received through the corresponding module. In some embodiments, some (e.g., two or more) of the cellular module, the WiFi module, the Bluetooth module, the GNSS module or the NFC module may be included in one integrated chip (IC) or IC package.

The RF module may, for example, transmit and receive communication signal (e.g., RF signals). The RF module may include, for example, a transceiver, a power amp module (PAM), a frequency filter, a low noise amplifier (LNA), an antenna or the like. In another embodiment, at least one of the cellular module, the WiFi module, the Bluetooth module, the GNSS module or the NFC module may transmit and receive RF signals through a separate RF module.

In one embodiment, the communication module 805 may transfer situation information and/or biological information, and information about sound source data corresponding thereto, to the server 820, or may receive a sound source data request message or transfer a sound source data response message. Further, the communication module 805 may transfer sound source data to the second terminal 810 in response to the sound source data request message.

Referring to FIG. 8B, the second terminal 810 may include a processor 811, a sensor module 812, a memory 813, a communication module 814 and an output device 815. The components of the second terminal 810 according to an embodiment of the present disclosure may perform similar steps to those of the components of the first terminal 800. In various embodiments, the second terminal 810 may further include a touch screen.

The processor 811 may control the sensor module 813 to measure first biological information of the user, and transfer the measured first biological information to the server 820 or the first terminal 800. In one embodiment, if a biological information measurement request is received from the first terminal 800, the processor 811 may control the sensor module 813 to measure first biological information of the user, and transfer a response including the measured first biological information to the server 820 or the first terminal 800.

In various embodiments, in a case where the second terminal 810 further includes a touch screen, if a request for receiving user-preferred sound source data is received, the processor 811 may display, on the touch screen, a fifth user interface for obtaining first situation information of the user. The fifth user interface may include at least one object (e.g., text, icons, images or the like) representing the user's situation information (e.g., working, climbing, jogging, exercise, walking or the like).

If any one of at least one object is selected on the touch screen, the processor 811 may generate a sound source data request message including first situation information corresponding to the selected object, and transfer the generated sound source data request message to the first terminal 800 or the server 820.

In various embodiments, if any one of at least one object is selected on the touch screen, the processor 811 may measure first biological information of the user through the sensor module 812, generate a sound source data request message including first situation information corresponding to the selected object and the measured first biological information, and transfer the generated sound source data request message to the first terminal 800 or the server 820.

In various embodiments, the processor 811 may obtain user data such as user's location, schedule, time information, heart rate and blood pressure using the sensor module 812 or an application, and determine the user's situation based on the obtained user data. For example, if the user's location measured through the sensor module 812 is ‘mountain’ and the measured heart rate is ‘130 bpm’ or higher, the processor 811 may determine that the user is climbing, and obtain first situation information (e.g., climbing) depending on the determination.

If sound source data is received from the first terminal 800 or the server 820 through the communication module 814, the processor 811 may output the received sound source data through the output device (e.g., a speaker or the like) 815. In one embodiment, the processor 811 may play the received sound source data, and output the played sound source data through the output device 815. In various embodiments, if sound source streaming data is received from the first terminal 800 or the server 820, the processor 811 may output the received sound source streaming data through the output device 815.

The sensor module 812 may operate in a similar way to the sensor module 803 of the first terminal 800. In one embodiment, the sensor module 812 may include a biometric sensor for measuring a biological signal, and may include at least one of a gesture sensor, a gyro sensor, a barometer sensor, a magnetic sensor, an acceleration sensor, a grip sensor, a proximity sensor, a color sensor (e.g., red-green-blue (RGB) sensor), a temperature/humidity sensor, an illuminance sensor, or a ultra violet (UV) sensor in addition to the biometric sensor.

The memory 813 may store first situation information and/or first biological information, or store sound source data received from the communication module 814. The communication module 814 may operate in a similar way to the communication module 805 of the first terminal 800. In one embodiment, the communication module 814 may perform communication with the server 820, or perform short-range communication with the first terminal 800. The communication module 814 may transfer the first situation information and/or the first biological information to the server 820 or the first terminal 800, or receive sound source data from the server 820 or the first terminal 800.

The output device 815 may be a speaker, and may output the sound source data received from the first terminal 800 or the server 820.

Referring to FIG. 8C, the server 820 may include a processor 821, a communication module 822 and a memory 823.

In one embodiment, the processor 821 may receive user's situation information and/or biological information and information about user-preferred sound source data corresponding thereto from the first terminal 800 or the second terminal 810 through the communication module 822. The processor 821 may store the received situation information and/or biological information and information about user-preferred sound source data corresponding thereto in the memory 823.

In one embodiment, the processor 821 may receive a sound source data request message including first situation information and/or first biological information of the user from the first terminal 800 or the second terminal 810 through the communication module 822. The processor 821 may search the memory 823 for sound source data corresponding to the first situation information and/or first biological information included in the received sound source data request message, and transfer a sound source data response message including the searched sound source data to the first terminal 800 or the second terminal 810. In various embodiments, if the sound source data corresponding to the first situation information and/or the first biological information is not found, the processor 821 may search for similar sound source data corresponding to situation information and/or biological information similar to the first situation information and/or the first biological information, and transfer a sound source data response message including the searched similar sound source data to the first terminal 800 or the second terminal 810.

The communication module 822 may operate in a similar way to the communication module 805 of the first terminal 800. In one embodiment, the communication module 822 may receive user's situation information and/or biological information and information about user-preferred sound source data corresponding thereto from the first terminal 800 or the second terminal 810, and receive a sound source data request message including first situation information and/or first biological information of the user. Further, the communication module 822 may transfer a sound source data response message including sound source data (or similar sound source data) to the first terminal 800 or the second terminal 810.

The memory 823 may store the user's situation information and/or biological information and the information (or sound source data) about the user-preferred sound source data corresponding thereto, which are received from the first terminal 800 or the second terminal 810.

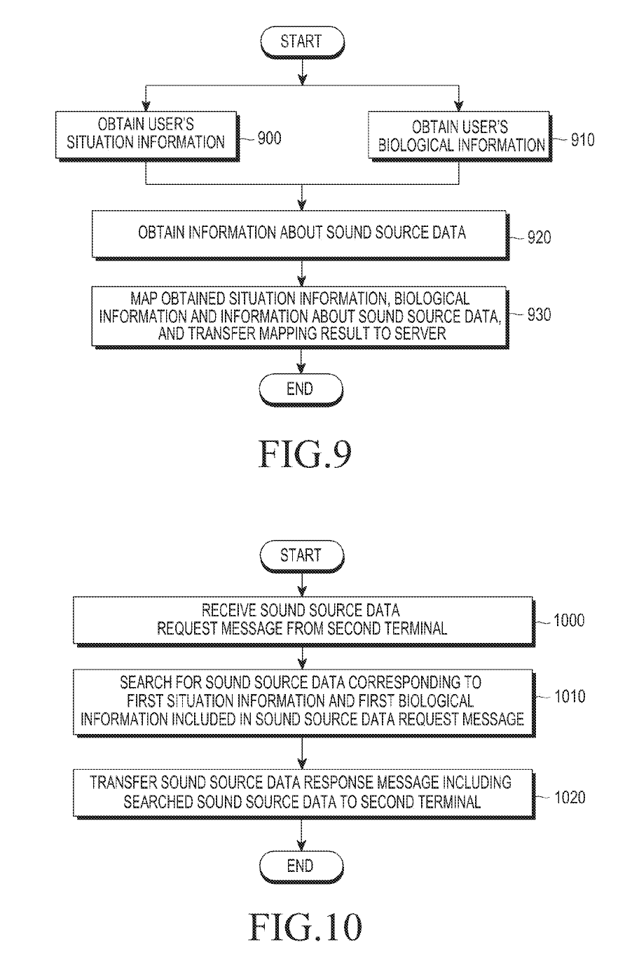

FIG. 9 illustrates a flowchart showing a process of providing sound source data corresponding to user's situation information and biological information in a first terminal according to various embodiments of the present disclosure. In various embodiments, steps 900 to 930 may be performed by any one of the first terminal (510, 610, 710 or 800), the server (520, 620 or 820), the second terminal (530, 630, 720 or 810), or the processor (801, 811 or 821).

Referring to FIG. 9, the first terminal 800 (e.g., the processor 801) may obtain situation information of the user in step 900, and obtain biological information of the user in step 910. Steps 900 and 910 may be performed in parallel.

In one embodiment, the first terminal 800 (e.g., the processor 801) may provide a first user interface for obtaining situation information of the user, and store the user's situation information selected (or entered) through the first user interface in the memory 804. If the situation information is selected (or entered) through the first user interface, the processor 801 may provide a second user interface for requesting measurement of biological information. If the measurement of biological information is requested through the second user interface, the processor 801 may control the sensor module 803 to measure the biological information.

In step 920, the first terminal 800 (e.g., the processor 801) may obtain information about sound source data. In one embodiment, the first terminal 800 (e.g., the processor 801) may provide a third user interface for selecting user-preferred sound source data, and store information about sound source data selected through the third user interface, in the memory 804.

In step 930, the first terminal 800 (e.g., the processor 801) may map the obtained situation information, biological information and information about sound source data corresponding thereto, and transfer the mapping result to the server 820.

FIG. 10 illustrates a flowchart showing a process of providing sound source data corresponding to user's situation information and biological information in a server according to various embodiments of the present disclosure. In various embodiments, steps 1000 to 1020 may be performed by any one of the first terminal (510, 610, 710 or 800), the server (520, 620 or 820), the second terminal (530, 630, 720 or 810), or the processor (801, 811 or 821).

Referring to FIG. 10, in step 1000, the server 820 (e.g., the processor 821) may receive a sound source data request message from the second terminal 810. In one embodiment, the sound source data request message may include first situation information and first biological information obtained from the second terminal 810.

In step 1010, the server 820 (e.g., the processor 821) may search for sound source data corresponding to the first situation information and the first biological information included in the sound source data request message. In one embodiment, the server 820 (e.g., the processor 821) may search for sound source data (or information about sound source data) corresponding to the first situation information and the first biological information from among at least one sound source data (or information about sound source data) included in the memory 823.

In step 1020, the server 820 (e.g., the processor 821) may transfer a sound source data response message including the searched sound source data to the second terminal 810. In one embodiment, the sound source data response message may include sound source data, or may include sound source streaming data obtained by streaming sound source data, or may include information about sound source data.

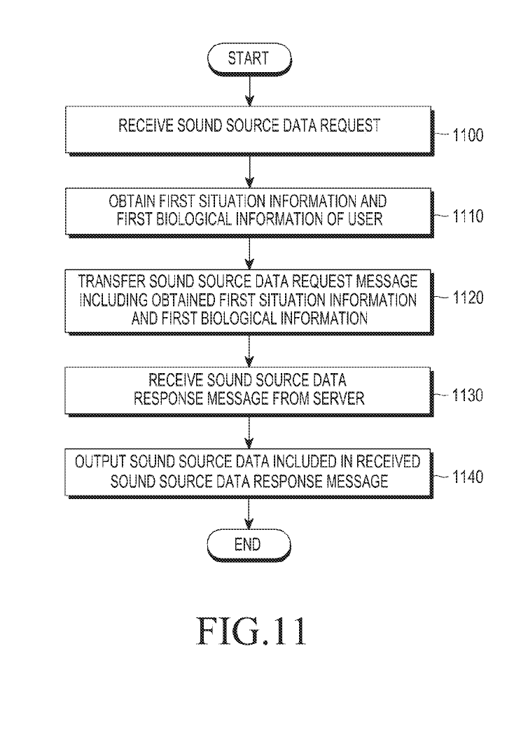

FIG. 11 illustrates a flowchart showing a process of providing sound source data corresponding to user's situation information and biological information in a second terminal according to various embodiments of the present disclosure. In various embodiments, steps 1100 to 1140 may be performed by any one of the first terminal (510, 610, 710 or 800), the server (520, 620 or 820), the second terminal (530, 630, 720 or 810), or the processor (801, 811 or 821).

Referring to FIG. 11, in step 1100, the second terminal 810 (e.g., the processor 811) may receive a sound source data request. In one embodiment, the second terminal 810 (e.g., the processor 811) may receive a biological information measurement request from the first terminal 800, or if the second terminal 810 (e.g., the processor 811) further includes a touch screen, a request for receiving user-preferred sound source data may be entered through the touch screen.

In step 1110, the second terminal 810 (e.g., the processor 811) may obtain first situation information and first biological information of the user. In one embodiment, the second terminal 810 (e.g., the processor 811) may display, on the touch screen, a fifth user interface for obtaining first situation information of the user, and receive the first situation information through the fifth user interface. Otherwise, the second terminal 810 (e.g., the processor 811) may determine the user's situation by measuring the location and/or the amount of exercise of the user through the sensor module 812 or by measuring the location and/or biological information of the user, thereby to obtain first situation information. In one embodiment, the second terminal 810 (e.g., the processor 811) may measure first biological information of the user through the sensor module 812.

In step 1120, the second terminal 810 (e.g., the processor 811) may transfer a sound source data request message including the obtained first situation information and first biological information to the server 820.

In step 1130, the second terminal 810 (e.g., the processor 811) may receive a sound source data response message from the server 820. In one embodiment, the sound source data response message may include sound source data that is searched for by the server in response the first situation information and the first biological information, or may include sound source data corresponding to situation information and biological information similar to the first situation information and the first biological information.

In step 1140, the second terminal 810 (e.g., the processor 811) may output sound source data included in the received sound source data response message. In one embodiment, the second terminal 810 (e.g., the processor 811) may output sound source data or sound source streaming data through the output device (e.g., the speaker) 815.

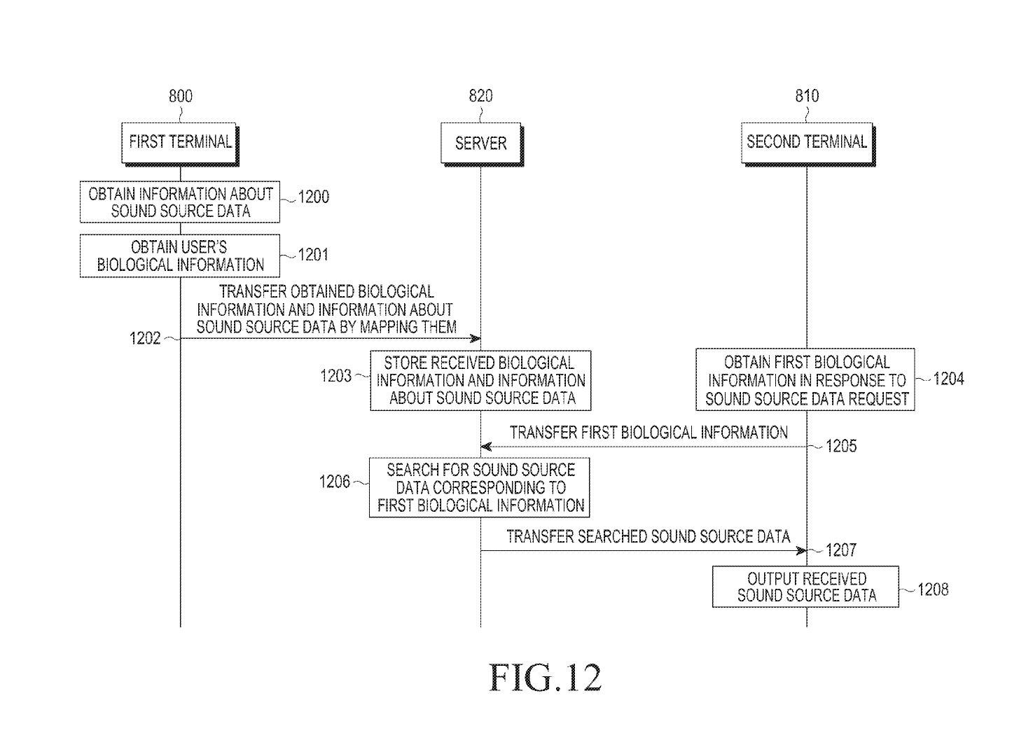

FIG. 12 illustrates a flowchart showing a process of providing sound source data corresponding to user's biological information in a sound source providing system according to various embodiments of the present disclosure.

Referring to FIG. 12, the first terminal 800 may obtain information about sound source data in step 1200. In one embodiment, if specific sound source data is selected while the first terminal 800 is playing the sound source data, the first terminal 800 may determine the selected sound source data as user-preferred sound source data, and store information about the determined sound source data.

In step 1201, the first terminal 800 may obtain biological information of the user. In one embodiment, the first terminal 800 may measure biological information of the user and store the measured biological information.

In various embodiments, if specific sound source data is selected while the first terminal 800 is playing the sound source data, the first terminal 800 may determine the selected sound source data as user-preferred sound source data, measure biological information of the user and store the measured biological information.

In step 1202, the first terminal 800 may map the obtained biological information and information about sound source data to each other, and transfer the mapping result to the server 820.

In step 1203, the server 820 may store the received biological information and information about sound source data.

In step 1204, the second terminal 810 may obtain first biological information in response to a sound source data request. In one embodiment, the second terminal 810 may measure first biological information of the user and store the measured first biological information.

In step 1205, the second terminal 810 may transfer the obtained first biological information to the server 820. In one embodiment, the second terminal 810 may generate a sound source data request message including the first biological information and transfer the generated sound source data request message to the server 820.

In step 1206, the server 820 may search for sound source data corresponding to the first biological information. In one embodiment, the server 820 may receive a sound source data request message, and search for sound source data corresponding to first biological information included in the received sound source data request message.

In step 1207, the server 820 may transfer the searched sound source data to the second terminal 810. In one embodiment, the server 820 may generate a sound source data response message including the searched sound source data, and transfer the generated sound source data response message to the second terminal 810.

In step 1208, the second terminal 810 may output the received sound source data. In one embodiment, the second terminal 810 may receive a sound source data response message and output sound source data included in the received sound source data response message.

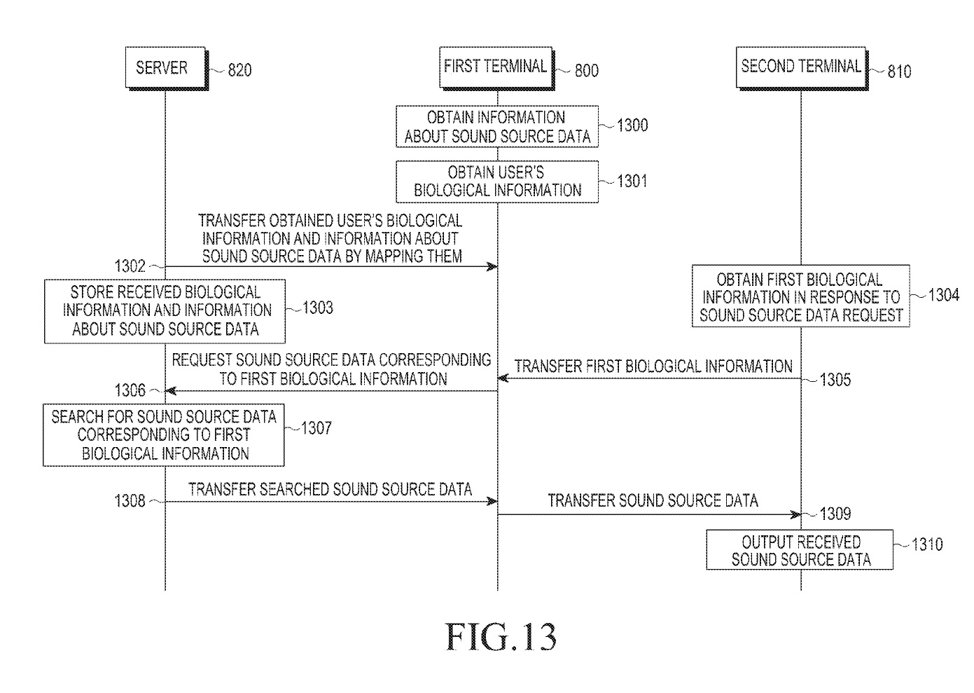

FIG. 13 illustrates a flowchart showing a process of providing sound source data corresponding to user's biological information in a sound source providing system according to various embodiments of the present disclosure.

Referring to FIG. 13, in step 1300, the first terminal 800 may obtain information about sound source data. In one embodiment, if specific sound source data is selected while the first terminal 800 is playing sound source data, the first terminal 800 may determine the selected sound source data as user-preferred sound source data, and store information about the determined sound source data.

In step 1301, the first terminal 800 may obtain biological information of the user. In one embodiment, the first terminal 800 may measure biological information of the user and store the measured biological information.

In various embodiments, if specific sound source data is selected while the first terminal 800 is playing sound source data, the first terminal 800 may determine the selected sound source data as user-preferred sound source data, measure biological information of the user and store the measured biological information.

In step 1302, the first terminal 800 may map the obtained biological information and information about sound source data to each other, and transfer the mapping result to the server 820.

In step 1303, the server 820 may store the received biological information and information about sound source data.

In step 1304, the second terminal 810 may obtain first biological information in response to a sound source data request. In one embodiment, the second terminal 810 may measure first biological information of the user, and store the measured first biological information.

In step 1305, the second terminal 810 may transfer the obtained first biological information to the first terminal 800.

In step 1306, the first terminal 800 may send a request for sound source data corresponding to the first biological information to the server 820. In one embodiment, the first terminal 800 may generate a sound source data request message including the received first biological information and transfer the generated sound source data request message to the server 820.

In step 1307, the server 820 may search for sound source data corresponding to the first biological information. In one embodiment, the server 820 may receive a sound source data request message, and search for sound source data corresponding to first biological information included in the received sound source data request message.

In step 1308, the server 820 may transfer the searched sound source data to the first terminal 800. In one embodiment, the server 820 may generate a sound source data response message including the searched sound source data, and transfer the generated sound source data response message to the first terminal 800.

In step 1309, the first terminal 800 may transfer the received sound source data to the second terminal 810. In one embodiment, the first terminal 800 may receive a sound source data response message and transfer sound source data included in the received sound source data response message to the second terminal 810.

In step 1310, the second terminal 810 may output the received sound source data.

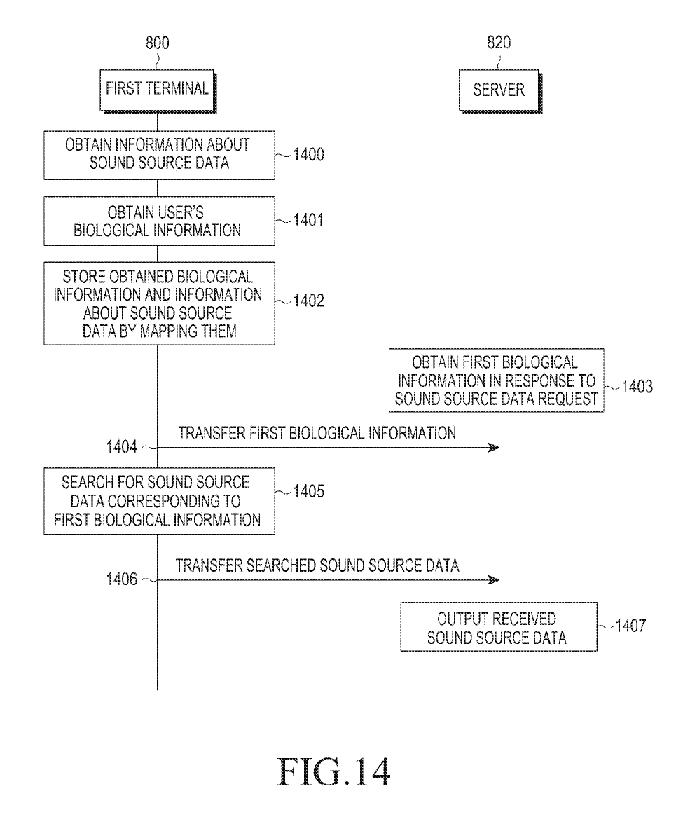

FIG. 14 illustrates a flowchart showing a process of providing sound source data corresponding to user's biological information in a sound source providing system according to various embodiments of the present disclosure.

Referring to FIG. 14, in step 1400, the first terminal 800 may obtain information about sound source data. In one embodiment, if specific sound source data is selected while the first terminal 800 is playing sound source data, the first terminal 800 may obtain determine the selected sound source data as user-preferred sound source data, and store information about the determined sound source data.

In step 1401, the first terminal 800 may obtain biological information of the user. In one embodiment, the first terminal 800 may measure biological information of the user and store the measured biological information.

In various embodiments, if specific sound source data is selected while the first terminal 800 is playing sound source data, the first terminal 800 may determine the selected sound source data as user-preferred sound source data, measure biological information of the user, and store the measured biological information.

In step 1402, the first terminal 800 may map the obtained biological information and information about sound source data to each other, and store the mapping result.

In step 1403, the second terminal 810 may obtain first biological information in response to a sound source data request. In one embodiment, the second terminal 810 may measure first biological information of the user, and store the measured first biological information.

In step 1404, the second terminal 810 may transfer the obtained first biological information to the first terminal 800. In one embodiment, the second terminal 810 may generate a sound source data request message including first biological information and transfer the generated sound source data request message to the first terminal 800.

In step 1405, the first terminal 800 may search for sound source data corresponding to the first biological information. In one embodiment, the first terminal 800 may receive a sound source data request message, and search for sound source data corresponding to first biological information included in the received sound source data request message.

In step 1406, the first terminal 800 may transfer the searched sound source data to the second terminal 810. In one embodiment, the first terminal 800 may generate a sound source data response message including the searched sound source data, and transfer the generated sound source data response message to the second terminal 810.

In step 1407, the second terminal 810 may output the received sound source data. In one embodiment, the second terminal 810 may receive a sound source data response message, and output sound source data included in the received sound source data response message.

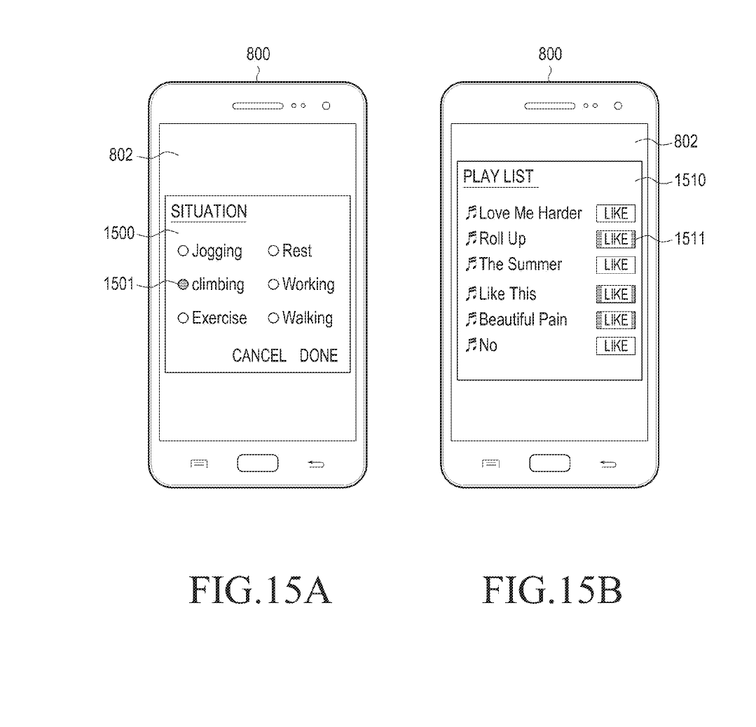

FIGS. 15A and 15B illustrate examples for a description of a process of providing sound source data corresponding to user's situation information and/or biological information in a first terminal according to various embodiments of the present disclosure.

Referring to FIG. 15A, the first terminal 800 may display, on a touch screen 802, a first user interface 1500 for obtaining user's situation information. The first user interface 1500 may include a first object (e.g., text, icons, images or the like) corresponding to at least one situation such as jogging, rest, climbing, working, exercise and walking, and a second object (e.g., a select icon, a select button or the like) for selecting the first object.

If a second object 1501 corresponding to ‘climbing’ that is the user's situation information is selected on the touch screen 802, the first terminal 800 may store ‘climbing’ corresponding to the selected second object 1501 as situation information, and display, on the touch screen 802, a third user interface 1510 for selecting user-preferred sound source data as shown in FIG. 15B. The third user interface 1510 may include a play list including information about at least one sound source data, and include a third object (e.g., a like icon, a like button or the like) for determining whether each sound source data is preferred by the user. If a third object 1511 corresponding to specific sound source data (e.g., roll up) is selected on the touch screen 802, the first terminal 800 may determine the sound source data (e.g., roll up) corresponding to the selected third object 1511 as user-preferred sound source data, map ‘climbing’, which is the obtained situation information, and information about the sound source data (e.g., roll up) to each other, and store the mapping result therein or transfer the mapping result to the server 820.

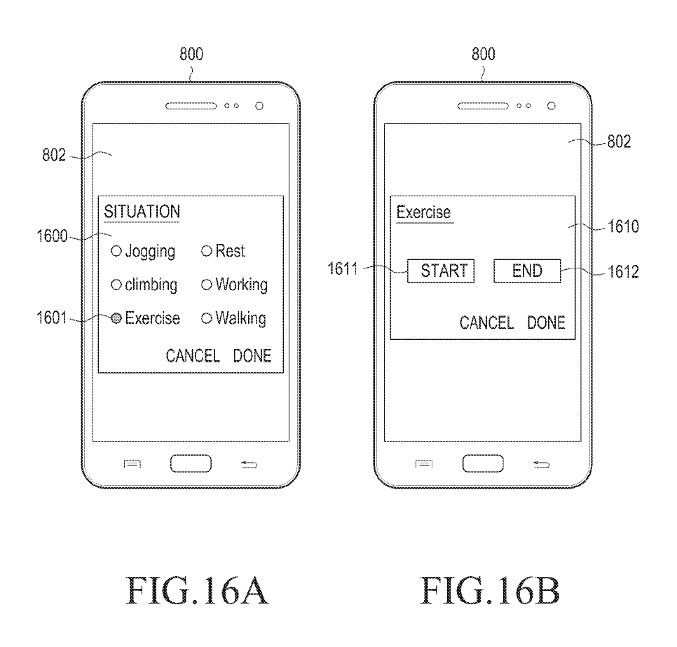

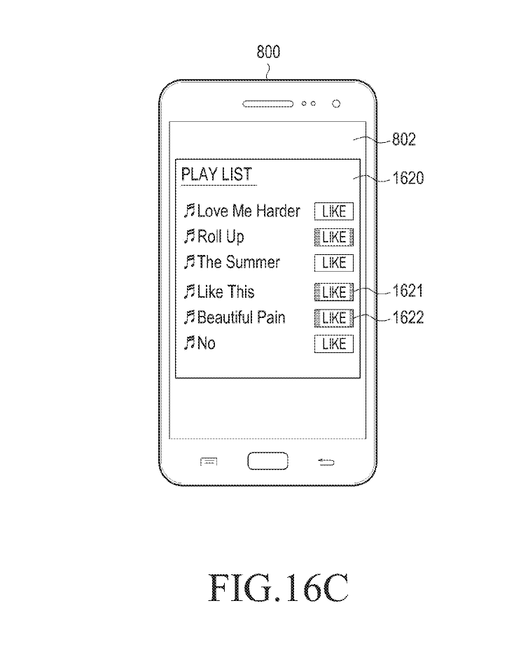

FIGS. 16A, 16B and 16C illustrate examples for a description of a process of providing sound source data corresponding to user's situation information and/or biological information in a first terminal according to various embodiments of the present disclosure.

Referring to FIG. 16A, the first terminal 800 may display, on the touch screen 802, a first user interface 1600 for obtaining situation information of the user. The first user interface 1600 may include a first object (e.g., text, icons, images or the like) corresponding to at least one situation such as jogging, rest, climbing, working, exercise and walking, and a second object (e.g., a select icon, a select button or the like) for selecting the first object.

If a second object 1601 corresponding to ‘exercise’ that is the user's situation information is selected on the touch screen 802, the first terminal 800 may store ‘exercise’ corresponding to the selected second object 1601 as situation information, and display, on the touch screen 802, a second user interface 1610 for measuring biological information corresponding to ‘exercise’ as shown in FIG. 16B. The second user interface 1610 may include a start icon (or a start button) 1611 for measuring biological information at the start of exercise, and an end icon (or an end button) 1612 for measuring biological information at the end of exercise.

If the start icon (or the start button) 1611 is selected, the first terminal 800 may store biological information obtained by measuring the biological information at the start of exercise, and display, on the touch screen 802, a third user interface 1620 for selecting user-preferred sound source data as shown in FIG. 16C. If a third object 1621 corresponding to specific sound source data (e.g., like this) is selected on the touch screen 802, the first terminal 800 may determine the sound source data (e.g., like this) corresponding to the selected third object 1621 as user-preferred sound source data, map the biological information measured at the start of exercise and the information about the sound source data (e.g., like this) to each other, and store the mapping result therein or transfer the mapping result to the server 820.

If the end icon (or the end button) 1612 is selected, the first terminal 800 may measure biological information at the end of exercise, store the measured biological information, and display, on the touch screen 802, the third user interface 1620 for selecting user-preferred sound source data as shown in FIG. 16C. If a third object 1622 corresponding to specific sound source data (e.g., beautiful pain) is selected on the touch screen 802, the first terminal 800 may determine the sound source data (e.g., beautiful pain) corresponding to the selected third object 1622 as user-preferred sound source data, map the biological information measured at the end of exercise and the information about the sound source data (e.g., beautiful pain) to each other, and store the mapping result therein or transfer the mapping result to the server 820.

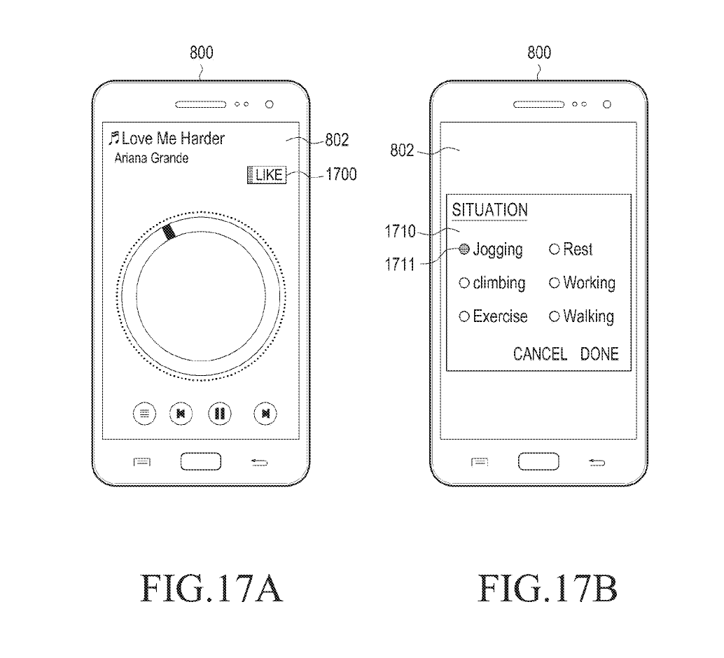

FIGS. 17A and 17B illustrate examples for a description of a process of providing sound source data corresponding to user's situation information and/or biological information in a first terminal according to various embodiments of the present disclosure.

Referring to FIG. 17A, if specific sound source data is selected (or is played) as a music playback application is run, the first terminal 800 may display a playback screen on the touch screen 802. The playback screen may include the title of sound source data being played, the singer name, and a like icon (or a like button) 1700 for determining whether the user prefers the sound source data. If the like icon (or a like button) 1700 is selected, the first terminal 800 may determine sound source data (e.g., love me harder) corresponding to the selected like icon (or a like button) 1700 as user-preferred sound source data, and display, on the touch screen 802, a first user interface 1710 for obtaining user's situation information as shown in FIG. 17B.

If a second object 1711 corresponding ‘jogging’ that is the user's situation information is selected on the touch screen 802, the first terminal 800 may map ‘jogging’ corresponding to the selected second object 1711 and information about the sound source data (e.g., love me harder) to each other, and store the mapping result therein or transfer the mapping result to the server 820.

In various embodiments, the first terminal 800 or the second terminal 810 may measure biological information of the user, and determine whether the measured biological information is identical to user's biological information pre-registered for an application of providing user-preferred sound source data. If the measured biological information is identical to the pre-registered biological information, the first terminal 800 or the second terminal 810 may automatically log in to the user account of the application. In this case, the first terminal 800 or the second terminal 810 may obtain situation information by determining the user's situation based on the measured biological information, and send a request for user-preferred sound source data to the server 820 based on the obtained situation information. If sound source data is received from the server 820, the first terminal 800 or the second terminal 810 may output the received sound source data.

As is apparent from the foregoing description, a user-preferred sound source may be provided based on a biological signal, so that the user may listen to a user-preferred sound source depending on the user's situation.

The terminal may measure a biological signal while the user is listing to the music, and match in advance feature information of the measured biological signal to feature information of a feature sound source. Therefore, in the future, the terminal may automatically select the user-preferred music using the measured biological signal.

Further, the terminal may match feature information of a biological signal to feature information of a feature sound source selected by the user, thereby increasing the possibility of retrieving the music similar to the user-preferred music.

While the user listens to the music, the bio-signal of the user is measured and bio-signal feature information about the measured bio-signal is matched to sound source feature information in advance, thereby enabling subsequent automatic selection of a user preferred sound source by using the measured bio-signal.

While the disclosure has been shown and described with reference to certain embodiments thereof, it will be understood by those skilled in the art that various changes in form and details may be made therein without departing from the spirit and scope of the disclosure as defined by the appended claims and their equivalents.

What is claimed is:

1. A method for providing a sound source in a first electronic device, the method comprising:
obtaining biological information of a user;
obtaining information about sound source data corresponding to the obtained biological information; and
mapping the obtained biological information to the obtained information about the sound source data and transferring the mapping result to a server.

2. The method of claim 1, further comprising:
obtaining situation information of the user; and
mapping the obtained situation information and biological information to the obtained information about the sound source data and transferring the mapping result to the server.

3. The method of claim 1, further comprising:
if first biological information is received from a second electronic device, transferring a sound source data request message including the received first biological information to the server; and
if a sound source data response message is received from the server, transferring sound source data included in the received sound source data response message to the second electronic device.

4. The method of claim 1, further comprising:
if first biological information is received from a second electronic device, searching for sound source data corresponding to the received first biological information; and
transferring the searched sound source data to the second electronic device.

5. The method of claim 1, further comprising:
if first situation information and first biological information are received from a second electronic device, transferring a sound source data request message including the received first situation information and first biological information to the server; and
if a sound source data response message is received from the server, transferring sound source data included in the received sound source data response message to the second electronic device.

6. The method of claim 1, further comprising:
if first situation information and first biological information are received from a second electronic device, searching for sound source data corresponding to the received first situation information and first biological information; and
transferring the searched sound source data to the second electronic device.

7. The method of claim 1, further comprising:
if first biological information is received from a second electronic device, searching for sound source data corresponding to the received first biological information;
if the sound source data corresponding to the received first biological information is not found, searching for similar sound source data corresponding to biological information similar to the first biological information; and
transferring the searched similar sound source data to the second electronic device.

8. The method of claim 7, wherein the similar biological information is set to have a measurement value, a difference of which from a measurement value of the first biological information is less than a predetermined threshold.

9. An electronic device for providing a sound source, comprising:
a sensor module configured to measure biological information of a user; and
a processor configured to obtain situation information of the user, obtain information about sound source data corresponding to the obtained biological information, map the obtained biological information to the obtained information about the sound source data, and transfer the mapping result to a server.

10. The electronic device of claim 9, wherein the processor is further configured to obtain situation information of the user, map the obtained situation information and biological information to the obtained information about the sound source data, and transfer the mapping result to the server.

11. The electronic device of claim 9, wherein the processor is further configured to;
if first biological information is received from a second electronic device, transfer a sound source data request message including the received first biological information to the server; and
if a sound source data response message is received from the server, transfer sound source data included in the received sound source data response message to the second electronic device.

12. The electronic device of claim 9, wherein the processor is further configured to, if first biological information is received from a second electronic device, search for sound source data corresponding to the received first biological information and transfer the searched sound source data to the second electronic device.

13. The electronic device of claim 9, wherein the processor is further configured to:
if first situation information and first biological information are received from a second electronic device, transfer a sound source data request message including the received first situation information and first biological information to the server; and
if a sound source data response message is received from the server, transfer sound source data included in the received sound source data response message to the second electronic device.

14. The electronic device of claim 9, wherein the processor is further configured to, if first situation information and first biological information are received from a second electronic device, search for sound source data corresponding to the received first situation information and first biological information and transfer the searched sound source data to the second electronic device.

15. The electronic device of claim 9, wherein the processor is further configured to:
if first biological information is received from a second electronic device, search for sound source data corresponding to the received first biological information; and
if the sound source data corresponding to the received first biological information is not found, search for similar sound source data corresponding to biological information similar to the first biological information and transfer the searched similar sound source data to the second electronic device.

16. The electronic device of claim 9, wherein the similar biological information is set to have a measurement value, a difference of which from a measurement value of the first biological information is less than a predetermined threshold.
